(19) United States
(12) Patent Application Publication
(10) Pub. No.: US 2024/0250791 A1
(43) Pub. Date: Jul. 25, 2024

(54) PHASE TRACKING REFERENCE SIGNAL CONFIGURATION AND INDICATION METHOD AND APPARATUS

(71) Applicant: ZTE Corporation, Shenzhen (CN)

(72) Inventors: Meng Mei, Shenzhen (CN); Bo Gao, Shenzhen (CN); Yang Zhang, Shenzhen (CN); Ke Yao, Shenzhen (CN)

(21) Appl. No.: 18/395,223

(22) Filed: Dec. 22, 2023

Related U.S. Application Data
(63) Continuation of application No. PCT/CN2023/073209, filed on Jan. 19, 2023.

(51) Int. Cl. H04L 5/00; H04W 72/232

(52) U.S. Cl. CPC H04L 5/0051; H04W 72/232

(57) ABSTRACT

This disclosure is directed to methods, systems, and devices related to wireless communication, and more specifically, to determine an association between demodulation reference signal (DMRS) ports and phase tracking reference Signal (PTRS) ports for uplink transmission. A method of wireless communication, comprising receiving, by a wireless communication device, an indication with a number of bits; wherein the indication is indicated in a downlink control information (DCI); and determining, by the wireless communication device, an association between a number of demodulation reference signal (DMRS) ports and a number of phase tracking reference Signal (PTRS) ports according to the indication.

### CROSS-REFERENCE TO RELATED APPLICATION

This application is a continuation and claims priority to International Application No. PCT/CN2023/073209, filed on Jan. 19, 2023, the disclosure of which is hereby incorporated by reference herein in its entirety.

### TECHNICAL FIELD

This disclosure is directed generally to wireless communications.

### BACKGROUND

Wireless communication technologies are moving the world toward an increasingly connected and networked society. The rapid growth of wireless communications and advances in technology has led to greater demand for capacity and connectivity. Other aspects, such as energy consumption, device cost, spectral efficiency, and latency are also important to meeting the needs of various communication scenarios. In comparison with the existing wireless networks, next generation systems and wireless communication techniques need to provide support for an increased number of users and devices, as well as support an increasingly mobile society.

### SUMMARY

Various techniques are disclosed that can be implemented by embodiments in mobile communication technology, including 5th Generation (5G), new radio (NR), 4th Generation (4G), and long-term evolution (LTE) communication systems.

In one example aspect, a wireless communication method is disclosed. The method includes receiving, by a wireless communication device, an indication with a number of bits; wherein the indication is indicated in a downlink control information (DCI); and determining, by the wireless communication device, an association between a number of demodulation reference signal (DMRS) ports and a number of phase tracking reference Signal (PTRS) ports according to the indication.

In another example aspect, another wireless communication method is disclosed. The method includes transmitting, to a wireless communication device, an indication with a number of bits; wherein the indication is indicated in a downlink control information (DCI); and determining, by the wireless communication device, an association between a number of demodulation reference signal (DMRS) ports and a number of phase tracking reference Signal (PTRS) ports according to the indication.

In yet another exemplary aspect, the above-described methods are embodied in the form of a computer-readable medium that stores processor-executable code for implementing the method.

In yet another exemplary embodiment, a device that is configured or operable to perform the above-described methods is disclosed. The device comprises a processor configured to implement the method.

The above and other aspects and their implementations are described in greater detail in the drawings, the descriptions, and the claims.

### BRIEF DESCRIPTION OF THE DRAWINGS

FIG. 1 illustrates an example of a sounding reference signal port associated with two panels.

FIG. 2 is a flowchart illustrating an example method.

FIG. 3 is a flowchart illustrating an example method.

FIG. 4 is a block diagram example of a wireless communication system.

FIG. 5 is a flowchart of an example method of wireless communication.

### DETAILED DESCRIPTION

Section headings are used in the present document only to improve readability and do not limit scope of the disclosed embodiments and techniques in each section to only that section. Certain features are described using the example of Fifth Generation (5G) wireless protocol. However, applicability of the disclosed techniques is not limited to only 5G wireless systems.

In the new radio (NR) design, up to four demodulation reference signal (DMRS) ports are supported for one user equipment (UE), and up to two phase tracking reference Signal (PTRS) ports are supported. One PTRS port can be used for phase noise estimation and compensation for the DMRS estimation, therefore, the PTRS port should be associated with one DMRS port.

In current specification, two bits are used for the PTRS-DMRS association in a downlink control information (DCI) field, as shown in Table 1-3. When the number of DMRS ports share one PTRS port, 2 bits are used to indicate which DMRS port is associated with the PTRS.

Table 1 shows four DMRS ports share PTRS port 0, and two bits in the DCI indicates which scheduled DMRS port of the four DMRS ports is associated with PTRS port 0.

TABLE 1
PTRS-DMRS association for UL PTRS port 0

| Value | DMRS port |
|---|---|
| 0 | 1^{st} scheduled DMRS port |
| 1 | 2^{nd} scheduled DMRS port |
| 2 | 3^{rd} scheduled DMRS port |
| 3 | 4^{th} scheduled DMRS port |

Table 2 shows two PTRS ports are supported, and two DMRS ports share one PTRS port, so 2 bits are used to indicate the association of the DMRS ports and the two PTRS port, and each bit is used to indicate which DMRS port is associated with PTRS port 0 and the other bit is used to indicated which DMRS port is associated with PTRS port 1.

TABLE 2
PTRS-DMRS association for UL PTRS ports 0 and 1

| Value | | Value | |
|---|---|---|---|
| of MSB | DMRS port | of LSB | DMRS port |
| 0 | 1^{st} DMRS port which | 0 | 1^{st} DMRS port which |
| | shares PTRS port 0 | | shares PTRS port 1 |
| 1 | 2^{nd} DMRS port which | 1 | 2^{nd} DMRS port which |
| | shares PTRS port 0 | | shares PTRS port 1 |

Table 1 & 2 show that the DMRS port in each table is corresponding to one sounding reference signal (SRS) resource indicator field and/or precoding information and number of layers field.

Table 3 shows two SRS resource indicator fields and/or precoding information and that a number of layers fields, and each bit is used for PTRS-DMRS association of the corresponding SRS resource indicator field and/or Precoding information and the number of layers field.

TABLE 3
PTRS-DMRS association for UL PTRS port
0 or for the actual UL PT-RS port

| Value | | Value | |
|---|---|---|---|
| of MSB | DMRS port | of LSB | DMRS port |
| 0 | 1^{st} scheduled DMRS | 0 | 1st scheduled DMRS |
| | port corresponding to | | port corresponding to |
| | SRS resource indicator | | Second SRS resource |
| | field and/or Precoding | | indicator field and/ |
| | information and number | | or Second Precoding |
| | of layers field | | information field |
| 1 | 2^{nd} scheduled DMRS | 1 | 2nd scheduled DMRS |
| | port corresponding to | | port corresponding to |
| | SRS resource indicator | | Second SRS resource |
| | field and/or Precoding | | indicator field and/ |
| | information and number | | or Second Precoding |
| | of layers field | | information field |

### Embodiment 1

One antenna port group is determined by one starting port index per port group and a number of consecutive ports. That is to say, the same number and index of antenna port is configured or indicated in one group, e.g., SRS ports.

For a partial coherent codebook based UL transmission, one PTRS port can be shared by several SRS ports or DMRS ports. For one antenna port group, one PTRS is supported, and all the DMRS ports associated with this one antenna port group share the same PTRS port.

In case of more than one DMRS ports are supported and to be associated or indicated in one antenna port group, these DMRS ports should be with a same codeword.

In case of different codewords are supported for the DMRS ports associated within one antenna port group, the PTRS should be associated with the DMRS port associated with the codeword that is indicated or associated with the higher modulation coding scheme (MCS).

If four antenna port groups are supported or indicated, up to two DMRS can be supported for one antenna port group, and one bit in DCI field can be used to indicated which DMRS port is associated with the PTRS port. And a total number of 4 bits are needed.

In case of one codeword is supported in one antenna port group, 1 bit is used to indicated which of the two DMRS port is associated with the shared PTRS.

In case of two codewords are supported in one antenna port group, the PTRS is associated with the DMRS port that associated with the CW with higher MCS.

Table 4 shows the detailed association.

TABLE 4
PTRS-DMRS association for UL PTRS ports 0-3

| 1^{st} | | 2^{nd} | | 3^{rd} | | 4^{th} | |
|---|---|---|---|---|---|---|---|
| bit | DMRS port | bit | DMRS port | bit | DMRS port | bit | DMRS port |
| 0 | 1^{st} DMRS port | 0 | 1^{st} DMRS port | 0 | 1^{st} DMRS port | 0 | 1^{st} DMRS port |
| | associated | | associated | | associated | | associated |
| | with CW of | | with CW of | | with CW of | | with CW of |
| | higher MCS | | higher MCS | | higher MCS | | higher MCS |
| | which shares | | which shares | | which shares | | which shares |
| | PTRS port 0 | | PTRS port 1 | | PTRS port 2 | | PTRS port 2 |
| 1 | 2^{nd} DMRS port | 1 | 2^{nd} DMRS port | 1 | 2^{nd} DMRS port | 1 | 2^{nd} DMRS port |
| | associated | | associated | | associated | | associated |
| | with CW of | | with CW of | | with CW of | | with CW of |
| | higher MCS | | higher MCS | | higher MCS | | higher MCS |
| | which shares | | which shares | | which shares | | which shares |
| | PTRS port 0 | | PTRS port 1 | | PTRS port 2 | | PTRS port 2 |

If up to two antenna port groups are supported or indicated, up to four DMRS ports can be supported in one antenna port group.

From a transmit precoding matrix index (TPMI) indication for codebook based uplink transmission, if the indicated codebook in one antenna port group is a full coherent, then one PTRS port can be supported, and 2 bits can be used to indicated which DMRS port can be associated with the PTRS port, and a total number of 4 bits can be supported in the DCI. If two codewords are supported in one antenna port group, the PTRS port should be associated with the codeword with the higher MCS.

Table 5A shows the detailed association.

TABLE 5A
PTRS-DMRS association for UL PTRS ports 0 and 1

| Value | | Value | |
|---|---|---|---|
| of the | | of the | |
| first | | second | |
| 2 bits | DMRS port | 2 bits | DMRS port |
| 0 | 1^{st} scheduled DMRS port | 0 | 1^{st} scheduled DMRS port |
| | associated with CW of | | associated with CW of |
| | higher MCS which shares | | higher MCS which shares |
| | PTRS port 0 | | PTRS port 1 |
| 1 | 2^{nd} scheduled DMRS port | 1 | 2^{nd} scheduled DMRS port |
| | associated with CW of | | associated with CW of |
| | higher MCS which shares | | higher MCS which shares |
| | PTRS port 0 | | PTRS port 1 |
| 2 | 3^{rd} scheduled DMRS port | 2 | 3^{rd} scheduled DMRS port |
| | associated with CW of | | associated with CW of |
| | higher MCS which shares | | higher MCS which shares |
| | PTRS port 0 | | PTRS port 1 |
| 3 | 4^{th} scheduled DMRS port | 3 | 4^{th} scheduled DMRS port |
| | associated with CW of | | associated with CW of |
| | higher MCS which shares | | higher MCS which shares |
| | PTRS port 0 | | PTRS port 1 |

If up to four DMRS ports are associated with one antenna port group, two of the DMRS ports are associated with one codeword and the other two DMRS ports are associated with the other codewords, one bit is enough for the PTRS-DMRS association. The one bit is used to indicate which DMRS port of the codeword with higher MCS is associated with the shared PTRS port.

Table 5B shows the detailed association.

TABLE 5B
PTRS-DMRS association for UL PTRS ports 0 and 1

| Value | | Value | |
|---|---|---|---|
| of the | | of the | |
| first | | second | |
| bits | DMRS port | bits | DMRS port |
| 0 | 1^{st} scheduled DMRS port | 0 | 1^{st} scheduled DMRS port |
| | associated with CW of | | associated with CW of |
| | higher MCS which shares | | higher MCS which shares |
| | PTRS port 0 | | PTRS port 1 |
| 1 | 2^{nd} scheduled DMRS port | 1 | 2^{nd} scheduled DMRS port |
| | associated with CW of | | associated with CW of |
| | higher MCS which shares | | higher MCS which shares |
| | PTRS port 0 | | PTRS port 1 |

In case of more than three DMRS ports are associated with one codeword, if the 3rd or 4th DMRS ports is associated with the codeword with higher MCS, the one DMRS port should be indicated to associated with the shared PTRS ports, and 2 bits are need in DCI.

In the case of 4 or 8 antenna port groups are configured by RRC or MAC CE or indicated in DCI, and up to 2 PTRS ports are supported. Or in the case of 8 antenna port groups are configured or indicated, and up to 4 PTRS ports are supported. A number of antenna port groups share one PTRS port. For example, if 4 antenna port groups and 2 PTRS ports are enabled, the first two antenna port groups share PTRS port 0 and the other two antenna port groups share PTRS port. Similarly, if 8 antenna port groups are enabled, and if 2 PTRS ports are configured, the first four antenna port groups share PTRS port 0, the other 4 antenna port groups share PTRS port 1, and if 4 PTRS ports are configured, the first 2 antenna port groups share PTRS port 0, the second 2 antenna port groups share PTRS port 1, the third 2 antenna port groups share PTRS port 2, the last 2 antenna port groups share PTRS port 3.

The indication is enabled when at least one of following occurs: a MaxRank for uplink transmission is configured as more than 4, more than 4 layers uplink transmission is indicated in DCI, more than 4 DMRS ports are indicated for uplink transmission, a number of antenna port groups is configured by RRC or indicated by DCI, a total number of antenna ports for uplink transmission is more than 4, a number of configured or indicated SRS resource set is more than 1.

### Embodiment 2

Different numbers or configurations or indications of PTRS for different codewords.

Taking into the account that configurations and indications maybe different for different PTRS associated with different codewords, for DMRS ports associated with one Considering, if these DMRS ports are associated with one antenna port group from a radio resource control (RRC) configuration or DCI indication, only one PTRS is supported, and that the PTRS is associated with one of these DMRS ports are from DCI indication. If two antenna port group are supported, then two PTRS ports should be supported, and one PTRS port is associated with one antenna port group respectively.

If the DMRS ports associated with one codeword and one antenna port group are indicated from one CDM group, then only one PTRS is supported, and if these DMRS ports are indicated from two CDM groups, then two PTRS are supported, and each PTRS port is associated with one DMRS CDM group, and which of the DMRS ports is associated with the shared PTRS port should be indicated by DCI.

The number of PTRS ports and association between PTRS port and DMRS port should be determined based on the following priority rules:
The first-level: different PTRS(s) for different codewords;
The second-level: in a same codeword, if there are two antenna group, two PTRS are determined, otherwise, one PTRS is determined; and
The third-level: in a same codeword and a same antenna group, if there are two CDM, two different PTRS, otherwise, a PTRS.

### Embodiment 3

Take Rel-18 with 6 layers transmission as an example of indicated DMRS ports {0, 1, 2, 3, 8, 10}. For a downlink (DL) layer mapping rule, the first three layers {0, 1, 2} are associated with the first codeword, and the last three layers {3, 8, 10} are associated with the second codeword. For Rel-18 DMRS ports, {0, 1, 8} are associated with CDM group #0 and {2, 3, 10} are associated with CDM group #1.

If one antenna port group is associated with one CDM group, DMRS ports {0, 1, 8} are associated with one antenna port group, and DMRS ports {2, 3, 10} are associated with another antenna port group. In such case, two PTRS ports should be associated with the two antenna port group respectively regardless of codewords.

If two codewords are supported with different MCS, then the two PTRS port should be indicated or configured with different densities.

When one PTRS port is associated with one codeword, usually one antenna port group should be associated with one PTRS port because the antenna ports are coherent in one group.

When one codeword is associated with one antenna port group, the association maybe reflect by the TPMI design for a codebook based transmission and sounding reference signal (SRS) resource indicator (SRI) indication for a non-codebook based transmission.

In case of two antenna port groups are supported. For 5 layers transmission, TPMI of 2+3 should be supported. For 6 layers transmission, TPMI of 3+3 should be supported. For 7 layers transmission, TPMI of 3+4 should be supported. For 8 layers transmission, TPMI of 4+4 should be supported.

In the case of four antenna port groups are supported. For 5 layers transmission, TPMI of 1+1+1+2 or 1+1+2+1 should be supported. For 6 layers transmission, TPMI of 1+2+1+2 or 2+1+2+1 should be supported. For 7 layers transmission, TPMI of 2+1+2+2 or 1+2+2+2 should be supported. For 8 layers transmission, TPMI of 2+2+2+2 should be supported.

In case of up to four PTRS ports are supported, four antenna port groups are supported and up to four PTRS ports can be supported. If two codewords are configured, it should be determined which two antenna port groups are associated with one of the codeword.

By default, the first two antenna port groups or the first and the third port groups are associated with one codeword, the other two port groups are associated with the other codeword.

Alternatively, according to UE capability, UE should report which two antenna port groups are associated with one codeword, i.e., which two PTRS ports share one codeword. This capability is also associated with the TPMI design.

### Association of Antenna Port Group and CDM Group:

For a partial coherent codebook based transmission, from the TPMI indication introduced above for a rank 3 transmission, DMRS port 0 and DMRS port 1 are associated to a non-coherent codebook but within one CDM group as indicated in 38.212.

For Rel-18 DMRS with more than 4 layers transmission, if DMRS ports from one antenna port group are within one CDM group, the indicated DMRS ports should be modified. Take Rel-18 with 6 layers transmission for example, if DMRS ports {0, 1, 2, 3, 8, 10} are indicated, {0, 1, 8} are from one CDM group and {2, 3, 10} are from another CDM group. Therefore, for the TPMI design or the DMRS indication, an order of DMRS port index should be considered, e.g., an indication of {0, 1, 8, 2, 3, 10}.

For DMRS type 2, up to three CDM groups are supported, if only two antenna port group are supported. The association between the two antenna port groups and the three CDM groups should be investigated. For single symbol DMRS, only two CDM groups are supported. For double symbol DMRS, one or two CDM groups are supported, as shown in Table 6.

TABLE 6
Two Codewords:
Codeword 0 enabled
Codeword 1 enabled

| | Number of DMRS | | Number of |
|---|---|---|---|
| | CDM group(s) | | front-load |
| Value | without data | DMRS port(s) | symbols |
| 0 | 2 | 0, 1, 2, 3, 14 | 1 |
| 1 | 2 | 0, 1, 12, 2, 3, 14 | 1 |
| 2 | 2 | 0, 1, 12, 2, 3, 14, 15 | 1 |
| 3 | 2 | 0, 1, 12 13, 2, 3, 14, 15 | 1 |
| 4 | 2 | 0, 1, 2, 3, 6 | 2 |
| 5 | 2 | 0, 1, 2, 3, 6, 8 | 2 |
| 6 | 2 | 0, 1, 2, 3, 6, 7, 8 | 2 |
| 7 | 2 | 0, 1, 2, 3, 6, 7, 8, 9 | 2 |
| 8 | 1 | 0, 1, 6, 7, 12 | 2 |
| 9 | 1 | 0, 1, 6, 7, 12, 13 | 2 |
| 10 | 1 | 0, 1, 6, 7, 12, 13, 18 | 2 |
| 11 | 1 | 0, 1, 6, 7, 12, 13, 18, 19 | 2 |
| 12 | 2 | 2, 3, 8, 9, 14 | 2 |
| 13 | 2 | 2, 3, 8, 9, 14, 15 | 2 |
| 14 | 2 | 2, 3, 8, 9, 14, 15, 20 | 2 |
| 15 | 2 | 2, 3, 8, 9, 14, 15, 20, 21 | 2 |
| 16 | 3 | 4, 5, 10, 11, 16 | 2 |
| 17 | 3 | 4, 5, 10, 11, 16, 17 | 2 |
| 18 | 3 | 4, 5, 10, 11, 16, 17, 22 | 2 |
| 19 | 3 | 4, 5, 10, 11, 16, 17, 22, 22 | 2 |

### Embodiment 4

Taking into the account that one PTRS port can be shared by number of DMRS ports and on one orthogonal frequency-division multiplexing (OFDM) symbol, PTRS and a physical uplink shared channel (PUSCH) are mapped on different Resource elements (RE), different energy can be adopted for transmission of PTRS and the related PUSCH.

Considering the case of up to two PTRS ports are supported, the parameter Qp in table 7 is the PTRS port number, for a full coherent uplink (UL) transmission. Take rank 8 for an example, all 8 DMRS ports share one PTRS port, so the energy on each RE of the PTRS are 8 times to the each PUSCH, that is 10×log(rank number) 9 dB. For a partial coherent UL transmission, up to 4 DMRS ports share one PTRS port, if the PTRS is configured or determined as one port and the energy is 4 times to PUSCH, that is 6 dB. If two PTRS ports are used, considering on the REs that the other PTRS port 1 mapped cannot map PUSCH anymore, the energy can still be added on this PTRS port 0, which is 8 times to each PUSCH layer. Therefore, for both one and two PTRS ports, the energy would be 3Qp+3.

For a non-codebook based or a non-coherent codebook based UL transmission, only one SRS port share one PTRS port, and the power of other PUSCH cannot be used to enlarge the transmission power of PTRS. Therefore, if only one PTRS port is used, the energy would be 0, and if two PTRS ports are used, the transmission power would be double for each PTRS port, which is 3 dB.

TABLE 7
Factor related to PUSCH to PT-RS power ratio per layer per RE α_{PTRS}^{PUSCH}
The number of PUSCH layers (n_{layer}^{PUSCH})

| 5 | | 6 | | 7 | | | | |
|---|---|---|---|---|---|---|---|---|
| | Partial | | Partial | | Partial | 8 | | |
| | and non- | | and non- | | and non- | | | Non- |
| | coherent | | coherent | | coherent | | | coherent |
| | and non- | | and non- | | and non- | | | and non- |
| Full | codebook | Full | codebook | Full | codebook | Full | Partial | codebook |
| coherent | based | coherent | based | coherent | based | coherent | coherent | based |
| 6.99 | 3Qₚ − 3 | 7.78 | 3Qₚ − 3 | 8.45 | 3Qₚ − 3 | 9 | 3Qₚ + 3 | 3Qₚ − 3 |

For a full coherent transmission, the transmit power of PTRS is related the number of DMRS ports across all the antenna port group, i.e.,

$$( 10 log 10 ( {\sum }_{X = 0}^{N} {n}_{X} ) ) ,$$

wherein X is the index of antenna port groups, n is the number of DMRS ports in one antenna port group, and N is the total number of antenna port groups.

For a non-coherent codebook transmission and a non-codebook based transmission, the power of PTRS port is associated with the total number of PTRS ports across all the antenna port groups.

For a partial coherent transmission, the PTRS power is related to the PTRS port number, and the transmission layer shared one PTRS or one antenna port group.

For tow PTRS port, part of the PTRS power is boosted from the other orthogonal PTRS port, and a 3 dB can be added to one PTRS port. If a full coherent is supported in on antenna port, and n_{layerofoneAGP}^{PUSCH} layers can be supported for one antenna port group, then another part of the PTRS port power is obtained as 10 log 10(n_{layerofoneAGP}^{PUSCH}).

TABLE 8
The number of PUSCH layers (n_{layer}^{PUSCH})

| | Partial and | | Partial and | |
|---|---|---|---|---|
| | non-coherent | | non-coherent | |
| | and non- | | and non- | |
| Full | codebook | Full | codebook | Full |
| coherent | based | coherent | based | coherent |
| 5 | | 6 | | 7 |
| 6.99 | 3Qₚ − 3 + | 7.78 | 3Qₚ − 3 + | 8.45 |
| | 10log10(n_{layerofoneAGP}^{PUSCH}) | | 10log10(n_{layerofoneAGP}^{PUSCH}) | |
| 1 | | 2 | | 3 |
| 0 | 10log10(Qₚ) + | 3 | 10log10(Qₚ) + | 4.77 |
| | 10log10(n) | | 10log10(n) | |

| Partial and | | | Non- |
|---|---|---|---|
| non-coherent | | | coherent |
| and non- | | | and non- |
| codebook | Full | Partial | codebook |
| based | coherent | coherent | based |
| 7 | 8 | | |
| 3Qₚ − 3 + | 9 | 3Qₚ − 3 + | 3Qₚ − 3 |
| 10log10(n_{layerofoneAGP}^{PUSCH}) | | 10log10(n_{layerofoneAGP}^{PUSCH}) | |
| 3 | 4 | | |
| 10log10(Qₚ) + | 6 | 10log10(Qₚ) + | 10log10(Qₚ) |
| 10log10(n) | | 10log10(n) | |

If TPMI of codebook based transmission indicates the TPMI as a non-coherent for one antenna port group, the PTRS power can only be boosted from the number of PTRS port supported from all the antenna port groups.

### Embodiment 5

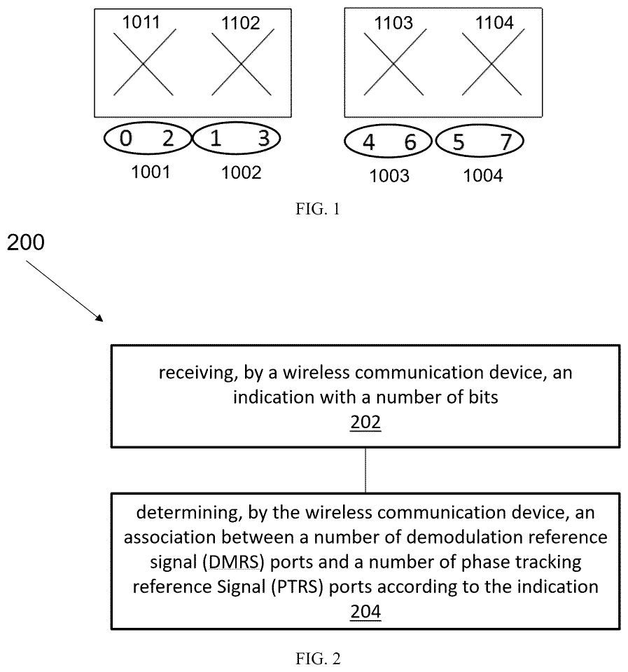

Taking into account that SRS port associated with the two panels, as shown in FIG. 1, SRS port 0 and 2 (1001), SRS port 1 and 3 (1002), SRS port 4 and 6 (1003), SRS port 5 and 7 (1004) share one PTRS port (1101, 1102, 1103, 1104) respectively. For codebook based transmission, when the TPMI field indicate a codebook for UL transmission and according to the DMRS ports indication, it will indicate which DMRS ports shares the PTRS ports, and the association between PTRS and DMRS port will also be indicated in the DCI.

Taking into the account that one PTRS port can be shared by number of DMRS ports, and on one OFDM symbol, PTRS and PUSCH are mapped on different REs, and different energy can be adopted for transmission of PTRS and the related PUSCH. The energy of PTRS and related PUSCH are associated with the transmission layer of PUSCH of each coherent type and the number of PTRS ports, as shown in Table 9, where the parameter Qp={1, 2, 3, 4} PTRS ports.

TABLE 9
Factor related to PUSCH to PT-RS power ratio per layer per RE α_{PTRS}^{PUSCH}
The number of PUSCH layers (n_{layer}^{PUSCH})

| 5 | | 6 | | 7 | | | | |
|---|---|---|---|---|---|---|---|---|
| | Partial | | Partial | | Partial | 8 | | |
| | and non- | | and non- | | and non- | | | Non- |
| | coherent | | coherent | | coherent | | | coherent |
| | and non- | | and non- | | and non- | | | and non- |
| Full | codebook | Full | codebook | Full | codebook | Full | Partial | codebook |
| coherent | based | coherent | based | coherent | based | coherent | coherent | based |
| 6.99 | 3Qₚ − 3 | 7.78 | 3Qₚ − 3 | 8.45 | 3Qₚ − 3 | 9 | 3Qₚ | 3Qₚ − 3 |

The PTRS power is related to the PTRS port number, and the transmission layer shared one PTRS or one antenna port group. Table 10 shows four PTRS ports.

TABLE 10
The number of PUSCH layers (n_{layer}^{PUSCH})

| | Partial and | | Partial and | | Partial and | | | Non- |
|---|---|---|---|---|---|---|---|---|
| | non-coherent | | non-coherent | | non-coherent | | | coherent |
| | and non- | | and non- | | and non- | | | and non- |
| Full | codebook | Full | codebook | Full | codebook | Full | Partial | codebook |
| coherent | based | coherent | based | coherent | based | coherent | coherent | based |
| 5 | | 6 | | 7 | | 8 | | |
| 6.99 | 10log10(Qₚ) + | 7.78 | 10log10(Qₚ) + | 8.45 | 10log10(Qₚ) + | 9 | 10log10(Qₚ) + | 10log10(Qₚ) |
| | 10log10(n) | | 10log10(n) | | 10log10(n) | | 10log10(n) | |
| 1 | | 2 | | 3 | | 4 | | |
| 0 | 10log10(Qₚ) + | 3 | 10log10(Qₚ) + | 4.77 | 10log10(Qₚ) + | 6 | 10log10(Qₚ) + | 10log10(Qₚ) |
| | 10log10(n) | | 10log10(n) | | 10log10(n) | | 10log10(n) | |

For a full coherent transmission, the transmit power of PTRS is related the number of DMRS ports across all the antenna port group that using the same SRS ports with the PTRS port, i.e., (10 log 10(n)), n is the number of DMRS ports in one antenna port group or transmitted on the same SRS ports with the PTRS or the transmission layer that transmitted by the same SRS port associated with the PTRS port if full coherent is supported and the number of antenna port group is one.

For a non-coherent codebook transmission and a non-codebook based transmission, the power of PTRS port is associated with the total number of PTRS ports across all the antenna port groups 10 log 10(Qₚ).

For a partial coherent codebook based transmission, if four antenna port groups are supported, and each PTRS is associated with one antenna port group, the PTRS port is associated with the number of PTRS ports across all the antenna port groups and the number of shared DMRS port in one antenna port group or the number of DMRS ports that share the same PTRS port by associated with the same SRS resource/port.

Accordingly, PTRS power is associated with at least one of: a number of orthogonal PTRS ports across all antenna port groups; a number of DMRS ports/transmission layers that share one PTRS port; a number of DMRS ports associated with one antenna port group; a number of DMRS ports associated with the same SRS resource set/resource/port in one antenna port group; or a number of antenna port groups.

### Embodiment 6

For simultaneous transmission of uplink transmission, up to two PTRS ports can be supported for more than one SRS resource sets.

Thus, several combinations can be supported such as one PTRS port can be associated with one SRS resource set, or the two PTRS ports can be associated with one SRS resource set is based on UE capability. If UE reports the capability to support one PTRS associated with one SRS resource set, or two PTRS ports associated with one SRS resource set and none of PTRS port associated with the other SRS resource set even which SRS resource set is supported to associated with the two PTRS ports, then the indication of PTRS and DMRS association in used to indicate the related association of PTRS.

gNB can configure the combination too by RRC, signaling or a medium access control (MAC) control element (MAC CE) or DCI.

For one PTRS port is associated with one SRS resource set. The 2 bits in the DCI is used to indicate the association of PTRS with the DMRS associated with one SRS resource set respectively.

In case of a partial coherent or a non-coherent codebook based transmission in one or each SRS resource set, two PTRS port is needed for one of the SRS resource sets, such as 4 antenna ports in one SRS resource set. In such case though, there is no need to indicate the association of PTRS-DMRS. That is to say, once two PTRS ports are enabled for one SRS resource set, the association indication in DCI can be ignored, and the PTRS port and DMRS port are one to one mapping.

### Embodiment 7

Full coherent transmission in one antenna port group is supported, and one PTRS port is supported in one antenna port group. Hence, the power ratio compared with the related PUSCH layer is associated with the number of antenna port group or the number of PTRS port, and the indicated number of transmission layer in one antenna port group.

For the number of antenna port group is configured by RRC or indicated by DCI as one, then full coherent transmission is supported, up to one PTRS port is enabled, and the power ratio of PTRS to the related PUSCH in one RE is associated with the indicated number of DMRS ports or rank, i.e., 10 log 10(n) introduced above. For rank 1 to 8, the power ratio of PTRS compared with the related PUSCH in one RE are: 0 dB, 3 dB, 4.77 dB, 6 dB, nearly 7(6.99) dB, 7.78 dB, 8.45 dB and 9 dB respectively.

If two or four antenna port groups are configured or indicated, the power of one PTRS port can be associated with the number of PTRS ports, if two PTRS ports are configured or indicated, a power boosting can be supported for each of the PTRS ports, and 3 dB is supported, and considering up to 4 DMRS port (PUSCH layers) can be associated with one antenna port group, and the number of DMRS ports in one antenna port group or transmitted on the same SRS ports with the PTRS or the transmission layer that transmitted by the same SRS port associated with the PTRS port can be associated with the power ratio of PTRS compared with the related PUSCH layer (1 layer) in one RE, i.e. 10 log 10(Qₚ)+10 log 10(n).

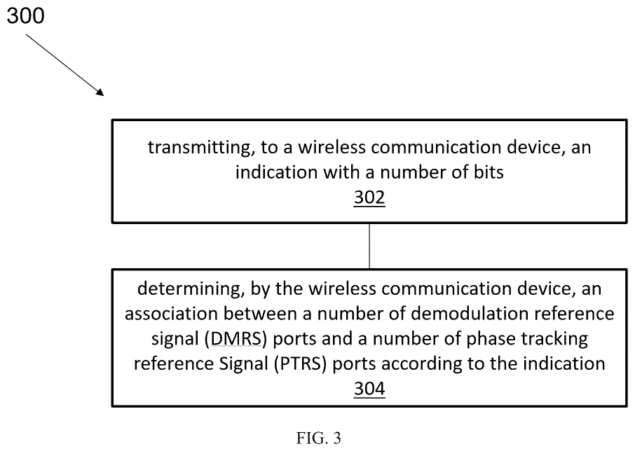

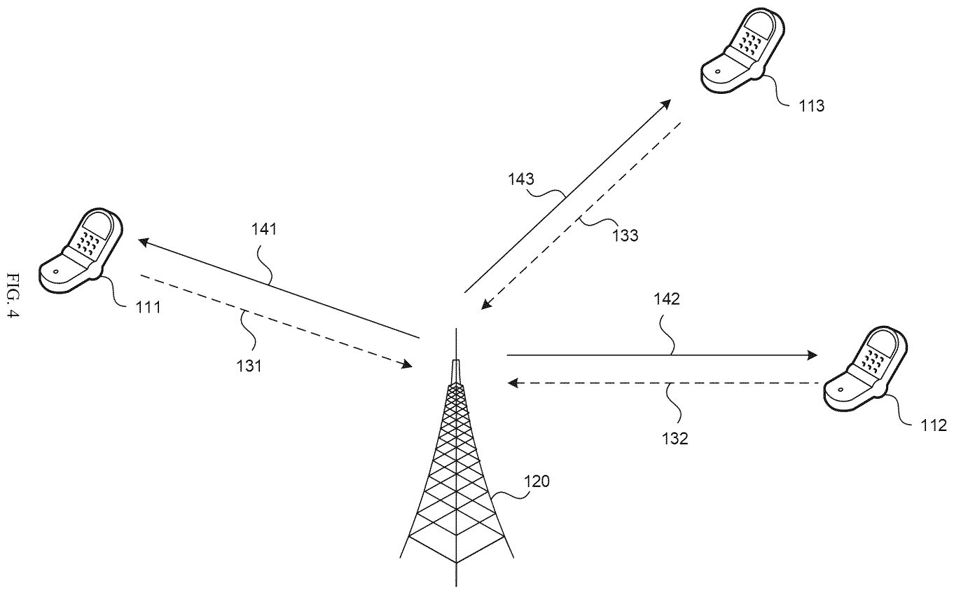

Accordingly, some preferred embodiments may use the following solutions.
1. A method of wireless communication, as disclosed in FIG. 2, including receiving, by a wireless communication device, an indication with a number of bits (202); wherein the indication is indicated in a downlink control information (DCI); and determining, by the wireless communication device, an association between a number of demodulation reference signal (DMRS) ports and a number of phase tracking reference Signal (PTRS) ports according to the indication (204). Additional details and examples are discussed with respect to embodiments 1-3.
2. The method of solution 1, wherein the indication is related to at least one of the following parameters: a number of antenna port groups; a number of codewords; a number of DMRS ports in any number of antenna port groups; a number of DMRS ports across all the antenna port groups; a number of DMRS ports associated with any codewords; a number of sounding reference signal (SRS) resource sets; a number of code division multiplexing (CDM) groups; or a number of codewords associated with any antenna port groups.
3. The method of solution 2, wherein the indication is enabled when at least one of following occurs: a MaxRank for uplink transmission is configured as more than 4; more than 4 layers uplink transmission is indicated in DCI; more than 4 DMRS ports are indicated for uplink transmission; a number of antenna port groups is configured by RRC or indicated by DCI; a total number of antenna ports for uplink transmission is more than 4; or a number of configured or indicated SRS resource set is more than 1
4. The method of solution 2, wherein one PTRS port associates with a DMRS port in one antenna port group.
5. The method of solution 4, wherein the DMRS port is associated with one codeword for a higher modulation coding scheme (MCS).
6. The method of solution 4, wherein up to one PTRS port is shared by a number of DMRS port in one CDM group.
7. The method of solution 2, wherein a number of antenna port groups share one PTRS port.
8. The method of solution 2, wherein a combination of the number of PTRS ports associated with the number of SRS resource set comprise at least one of: one PTRS port is associated with each SRS resource set respectively; none of PTRS port is associated with a first SRS resource set and two PTRS ports are associated with a second SRS resource set; none of PTRS port is associated with a second SRS resource set and two PTRS ports are associated with a first SRS resource set.
9. The method of solution 8, wherein the combination is configured by a radio resource control (RRC) signaling or a medium access control (MAC) control element (CE).
10. The method of solution 8, wherein the wireless communication device reports the combination to the network device based on communication device capability.
11. The method of solution 2, wherein the wireless communication device further determines the number of PTRS ports and the association between PTRS port and DMRS port according to the following rules: a first rule, wherein a number of PTRS ports are determined for one codeword; a second rule, wherein for a same codeword and for two antenna groups, either one or two PTRS ports are determined; or a third rule, wherein for a same codeword and a same antenna group, two PTRS ports are determined for two CDM groups or one PTRS port is determined otherwise.
12. The method of solution 2, wherein one PTRS port is shared by the DMRS ports associated with one codeword.
13. The method of solution 2, wherein the number of antenna port group is one or two, and a same codeword is associated with the antenna port groups.
14. The method of solution 13, wherein the association is reflected by a transmit precoding matrix index (TPMI) design for a codebook based transmission and a sounding reference signal (SRS) resource indicator (SRI) for a non-codebook based transmission.
15. The method of solution 2, wherein one antenna port group is associated with one CDM group, DMRS port are indicated according to an order of a DMRS port index.
16. The method of solution 1, wherein one PTRS port is shared by a number of DMRS ports; determining an uplink transmission power ratio of the PTRS port compared with transmission power of one PUSCH layer on one RE according to at least one of: a number of orthogonal PTRS ports across all antenna port groups; a number of DMRS ports or transmission layers that share one PTRS port; a number of DMRS ports associated with one antenna port group; a number of DMRS ports associated with a same or a coherent SRS resource set or a coherent SRS resource or a coherent SRS port in one antenna port group; a number of antenna port groups; a number of DMRS ports associated with a same SRS port(s) with a shared PTRS port; or a number transmission layers that transmitted by a same SRS port associated with the PTRS port.
17. The method of solution 16, wherein for a non-coherent codebook based transmission, a non-codebook based transmission, or eight antenna port groups configured by a radio resource control (RRC), a medium access control (MAC) control element (CE), or indicated in DCI, a PTRS power ratio is determined according to the number of orthogonal PTRS ports across all the antenna port groups.
18. The method of solution 16, wherein for a full coherent codebook based transmission or only one antenna port group configured by a radio resource control (RRC), a medium access control (MAC) control element (CE), or indicated in DCI, a PTRS power is determined according to the indicated number of DMRS ports associated with one antenna port group.
19. The method of solution 16, for a partial coherent codebook based transmission, or two or four antenna port groups configured by a radio resource control (RRC), a medium access control (MAC) control element (CE), or indicated in DCI, a PTRS power is determined according to the number of orthogonal PTRS ports across all the antenna ports and the DMRS ports associated with the same or the coherent SRS resource set(s) or SRS resource(s) or SRS port(s) in one antenna port group.
20. A method of wireless communication, as disclosed in FIG. 3, including transmitting, to a wireless communication device, an indication with a number of bits (302); wherein the indication is indicated in a downlink control information (DCI); and determining, by the wireless communication device, an association between a number of demodulation reference signal (DMRS) ports and a number of phase tracking reference Signal (PTRS) ports according to the indication (304). Additional details and examples are discussed with respect to embodiments 1-3.
21. The method of solution 20, wherein the indication is related to at least one of the following parameters: a number of antenna port groups; a number of codewords; a number of DMRS ports in any number of antenna port groups; a number of DMRS ports across all the antenna port groups; a number of DMRS ports associated with any codewords; a number of sounding reference signal (SRS) resource sets; a number of code division multiplexing (CDM) groups; or a number of codewords associated with any antenna port groups.
22. The method of solution 20, wherein the indication is enabled when at least one of following occurs: a MaxRank for uplink transmission is configured as more than 4; more than 4 layers uplink transmission is indicated in DCI; more than 4 DMRS ports are indicated for uplink transmission; a number of antenna port groups is configured by RRC or indicated by DCI; a total number of antenna ports for uplink transmission is more than 4; or a number of configured or indicated SRS resource set is more than 1
23. The method of solution 21, wherein one PTRS port associates with a DMRS port in one antenna port group.
24. The method of solution 23, wherein the DMRS port is associated with one codeword for a higher modulation coding scheme (MCS).
25. The method of solution 23, wherein up to one PTRS port is shared by a number of DMRS port in one CDM group.
26. The method of solution 21, wherein a number of antenna port groups share one PTRS port.
27. The method of solution 21, wherein a combination of the number of PTRS ports associated with the number of SRS resource set comprise at least one of: one PTRS port is associated with each SRS resource set respectively; none of PTRS port is associated with a first SRS resource set and two PTRS ports are associated with a second SRS resource set; or none of PTRS port is associated with a second SRS resource set and two PTRS ports are associated with a first SRS resource set.
28. The method of solution 27, wherein the combination is configured by a radio resource control (RRC) signaling or a medium access control (MAC) control element (CE).
29. The method of solution 21, wherein one PTRS port is shared by the DMRS ports associated with one codeword.
30. The method of solution 21, wherein the number of antenna port group is one or two, and a same codeword is associated with the antenna port groups.
31. The method of solution 30, wherein the association is reflected by a transmit precoding matrix index (TPMI) design for a codebook based transmission and a sounding reference signal (SRS) resource indicator (SRI) for a non-codebook based transmission.
32. The method of solution 21, wherein one antenna port group is associated with one CDM group, DMRS port are indicated according to an order of a DMRS port index.
33. The method of solution 20, wherein one PTRS port is shared by a number of DMRS ports; determining an uplink transmission power ratio of the PTRS port compared with transmission power of one PUSCH layer on one RE according to at least one of: a number of orthogonal PTRS ports across all antenna port groups; a number of DMRS ports or transmission layers that share one PTRS port; a number of DMRS ports associated with one antenna port group; a number of DMRS ports associated with a same or a coherent SRS resource set or a coherent SRS resource or a coherent SRS port in one antenna port group; a number of antenna port groups; a number of DMRS ports associated with a same SRS port(s) with a shared PTRS port; or a number transmission layers that transmitted by a same SRS port associated with the PTRS port.
34. The method of solution 33, claim 33, a PTRS power ratio is determined according to one of the following: wherein for a non-coherent codebook based transmission, a non-codebook based transmission, or eight antenna port groups configured by a radio resource control (RRC), a medium access control (MAC) control element (CE), or indicated in DCI, the PTRS power ratio is determined according to the number of orthogonal PTRS ports across all the antenna port groups; wherein for a full coherent codebook based transmission or only one antenna port group configured by a radio resource control (RRC), a medium access control (MAC) control element (CE), or indicated in DCI, the PTRS power is determined according to the indicated number of DMRS ports associated with one antenna port group; or wherein for a partial coherent codebook based transmission, or two or four antenna port groups configured by a radio resource control (RRC), a medium access control (MAC) control element (CE), or indicated in DCI, a PTRS power is determined according to the number of orthogonal PTRS ports across all the antenna ports and the DMRS ports associated with the same or the coherent SRS resource set(s) or SRS resource(s) or SRS port(s) in one antenna port group.
35. A communication apparatus comprising a processor configured to implement a method recited in any one or more of solutions 1 to 34.
36. A computer readable medium having code stored thereon, the code, when executed, causing a processor to implement a method recited in any one or more of solutions 1 to 34.

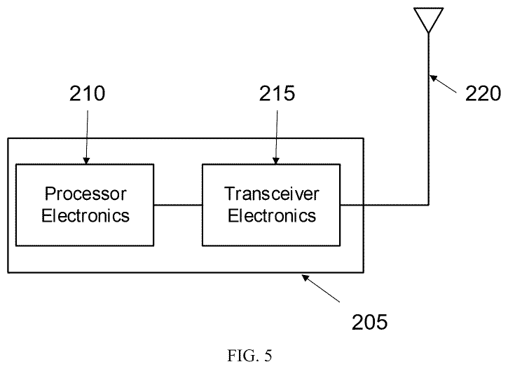

FIG. 4 shows an example of a wireless communication system (e.g., a long term evolution (LTE), 5G or NR cellular network) that includes a BS 120 and one or more user equipment (UE) 111, 112 and 113. In some embodiments, the uplink transmissions (131, 132, 133) can include uplink control information (UCI), higher layer signaling (e.g., UE assistance information or UE capability), or uplink information. In some embodiments, the downlink transmissions (141, 142, 143) can include DCI or high layer signaling or downlink information. The UE may be, for example, a smartphone, a tablet, a mobile computer, a machine to machine (M2M) device, a terminal, a mobile device, an Internet of Things (IOT) device, and so on.

FIG. 5 is a block diagram representation of a portion of an apparatus, in accordance with some embodiments of the presently disclosed technology. An apparatus 205 such as a network device or a base station or a wireless device (or UE), can include processor electronics 210 such as a microprocessor that implements one or more of the techniques presented in this document. The apparatus 205 can include transceiver electronics 215 to send and/or receive wireless signals over one or more communication interfaces such as antenna(s) 220. The apparatus 205 can include other communication interfaces for transmitting and receiving data. Apparatus 205 can include one or more memories (not explicitly shown) configured to store information such as data and/or instructions. In some implementations, the processor electronics 210 can include at least a portion of the transceiver electronics 215. In some embodiments, at least some of the disclosed techniques, modules or functions are implemented using the apparatus 205.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described, and other implementations, enhancements, and variations can be made based on what is described and illustrated in this document.

1-35. (canceled)

36. A method of wireless communication, comprising:
receiving, by a wireless communication device, an indication with a number of bits, wherein the indication is indicated in a downlink control information (DCI); and
determining, by the wireless communication device, an association between a number of demodulation reference signal (DMRS) ports and a number of phase tracking reference Signal (PTRS) ports according to the indication.

37. The method of claim 36, wherein the indication is related to at least one of the following parameters:
a number of antenna port groups;
a number of codewords;
a number of DMRS ports in any number of antenna port groups;
a number of DMRS ports across all the antenna port groups;
a number of DMRS ports associated with any codewords;
a number of sounding reference signal (SRS) resource sets;
a number of code division multiplexing (CDM) groups; or
a number of codewords associated with any antenna port groups.

38. The method of claim 36, wherein the indication is enabled when at least one of following occurs:
a MaxRank for uplink transmission is configured as more than 4;
more than 4 layers uplink transmission is indicated in DCI;
more than 4 DMRS ports are indicated for uplink transmission;
a number of antenna port groups is configured by RRC or indicated by DCI;
a total number of antenna ports for uplink transmission is more than 4; or
a number of configured or indicated SRS resource set is more than 1.

39. The method of claim 37, wherein one PTRS port associates with a DMRS port in one antenna port group, or up to one PTRS port is shared by a number of DMRS ports in one CDM group.

40. The method of claim 37, wherein a number of antenna port groups share one PTRS port.

41. The method of claim 37, wherein a combination of the number of PTRS ports associated with the number of SRS resource set comprise at least one of:
one PTRS port is associated with each SRS resource set respectively;
none of PTRS port is associated with a first SRS resource set and two PTRS ports are associated with a second SRS resource set; or
none of PTRS port is associated with a second SRS resource set and two PTRS ports are associated with a first SRS resource set, and
wherein the combination is configured by a radio resource control (RRC) signaling or a medium access control (MAC) control element (CE).

42. The method of claim 41, wherein the wireless communication device reports the combination to a network device based on communication device capability.

43. The method of claim 37, wherein the wireless communication device further determines the number of PTRS ports and the association between PTRS port and DMRS port according to the following rules:
a first rule, wherein a number of PTRS ports are determined for one codeword;
a second rule, wherein for a same codeword and for two antenna groups, either one or two PTRS ports are determined; or
a third rule, wherein for a same codeword and a same antenna group, two PTRS ports are determined for two CDM groups or one PTRS port is determined otherwise.

44. The method of claim 37, wherein the number of antenna port group is one or two, and a same codeword is associated with the antenna port groups, and wherein the association is reflected by a transmit precoding matrix index (TPMI) design for a codebook based transmission and a sounding reference signal (SRS) resource indicator (SRI) for a non-codebook based transmission.

45. The method of claim 36, wherein one PTRS port is shared by a number of DMRS ports, wherein the method further comprises:
determining an uplink transmission power ratio of the PTRS port compared with transmission power of one PUSCH layer on one resource element (RE), such that:
wherein, for a non-coherent codebook based transmission, a non-codebook based transmission, or eight antenna port groups configured by a radio resource control (RRC), a medium access control (MAC) control element (CE), or indicated in DCI, a PTRS power ratio is determined according to a number of orthogonal PTRS ports across all antenna port groups,
wherein, for a full coherent codebook based transmission or only one antenna port group configured by the RRC, the MAC CE, or indicated in the DCI, a PTRS power is determined according to an indicated number of DMRS ports associated with one antenna port group, and
wherein, for a partial coherent codebook based transmission, or two or four antenna port groups configured by the RRC, the MAC CE, or indicated in the DCI, a PTRS power is determined according to the number of orthogonal PTRS ports across all antenna ports and DMRS ports associated with a same or a coherent SRS resource set(s), a same or a coherent SRS resource(s), or a coherent SRS port(s) in one antenna port group.

46. A method of wireless communication, comprising:
transmitting, to a wireless communication device, an indication with a number of bits, wherein the indication is indicated in a downlink control information (DCI); and
determining, by the wireless communication device, an association between a number of demodulation reference signal (DMRS) ports and a number of phase tracking reference Signal (PTRS) ports according to the indication.

47. The method of claim 46, wherein the indication is related to at least one of the following parameters:
a number of antenna port groups;
a number of codewords;
a number of DMRS ports in any number of antenna port groups;
a number of DMRS ports across all the antenna port groups;
a number of DMRS ports associated with any codewords;
a number of sounding reference signal (SRS) resource sets;
a number of code division multiplexing (CDM) groups; or
a number of codewords associated with any antenna port groups.

48. The method of claim 46, wherein the indication is enabled when at least one of following occurs:
a MaxRank for uplink transmission is configured as more than 4;
more than 4 layers uplink transmission is indicated in DCI;
more than 4 DMRS ports are indicated for uplink transmission;
a number of antenna port groups is configured by RRC or indicated by DCI;
a total number of antenna ports for uplink transmission is more than 4; or
a number of configured or indicated SRS resource set is more than 1.

49. The method of claim 47, wherein one PTRS port associates with a DMRS port in one antenna port group, or up to one PTRS port is shared by a number of DMRS port in one CDM group.

50. The method of claim 47, wherein a number of antenna port groups share one PTRS port.

51. The method of claim 47, wherein a combination of the number of PTRS ports associated with the number of SRS resource set comprise at least one of:
one PTRS port is associated with each SRS resource set respectively;
none of PTRS port is associated with a first SRS resource set and two PTRS ports are associated with a second SRS resource set; or
none of PTRS port is associated with a second SRS resource set and two PTRS ports are associated with a first SRS resource set, and
wherein the combination is configured by a radio resource control (RRC) signaling or a medium access control (MAC) control element (CE).

52. The method of claim 47, wherein the number of antenna port group is one or two, and a same codeword is associated with the antenna port groups, and wherein the association is reflected by a transmit precoding matrix index (TPMI) design for a codebook based transmission and a sounding reference signal (SRS) resource indicator (SRI) for a non-codebook based transmission.

53. The method of claim 46, wherein one PTRS port is shared by a number of DMRS ports, wherein the method further comprises:
determining an uplink transmission power ratio of the PTRS port compared with transmission power of one PUSCH layer on one resource element (RE) such that:
wherein, for a non-coherent codebook based transmission, a non-codebook based transmission, or eight antenna port groups configured by a radio resource control (RRC), a medium access control (MAC) control element (CE), or indicated in DCI, a PTRS power ratio is determined according to a number of orthogonal PTRS ports across all antenna port groups,
wherein, for a full coherent codebook based transmission or only one antenna port group configured by the RRC, the MAC CE, or indicated in the DCI, a PTRS power is determined according to an indicated number of DMRS ports associated with one antenna port group, and
wherein, for a partial coherent codebook based transmission, or two or four antenna port groups configured by the RRC, the MAC CE, or indicated in the DCI, a PTRS power is determined according to the number of orthogonal PTRS ports across all antenna ports and DMRS ports associated with a same or a coherent SRS resource set(s), a same or a coherent SRS resource(s), or a coherent SRS port(s) in one antenna port group.

54. An apparatus for wireless communication, comprising:
one or more processors configured to:
receive, by a wireless communication device, an indication with a number of bits, wherein the indication is indicated in a downlink control information (DCI); and
determine, by the wireless communication device, an association between a number of demodulation reference signal (DMRS) ports and a number of phase tracking reference Signal (PTRS) ports according to the indication.

55. An apparatus for wireless communication, comprising:
one or more processor configured to:
transmit, to a wireless communication device, an indication with a number of bits, wherein the indication is indicated in a downlink control information (DCI); and
determine, by the wireless communication device, an association between a number of demodulation reference signal (DMRS) ports and a number of phase tracking reference Signal (PTRS) ports according to the indication.
